(19) United States
(12) Patent Application Publication
(10) Pub. No.: US 2021/0385578 A1
(43) Pub. Date: Dec. 9, 2021

(54) SOUND AMPLIFYING FACILITY FOR HEADPHONE

(71) Applicant: Oxti Corporation, Taipei (TW)

(72) Inventor: Chih Feng HO, Taipei (TW)

(21) Appl. No.: 16/892,337

(22) Filed: Jun. 4, 2020

(51) Int. Cl. H04R 5/033; H04R 5/04; H04R 1/10; H02J 50/80; H02J 50/12

(52) U.S. Cl. CPC H04R 5/033; H04R 5/04; H04R 2420/07; H02J 50/80; H02J 50/12; H04R 1/1025

(57) ABSTRACT

A sound amplifying facility includes a headphone having a wireless transmitting and receiving module for transmitting and receiving an information from an electric facility, and an amplifying mechanism having a signal receiving and amplifying module for receiving and amplifying the information from the headphone. The headphone includes a wireless charging module, and the amplifying mechanism includes a wireless charging unit for charging the headphone wirelessly. The amplifying mechanism includes a socket for engaging with the headphone. The socket includes a conductor, and the headphone includes a terminal for engaging with the conductor of the socket.

### BACKGROUND OF THE INVENTION

### 1. Field of the Invention

The present invention relates to a current or sound magnifying or amplifying device or facility for an earphone or headphone, and more particularly to a current or sound magnifying or amplifying device or facility for magnifying or amplifying the current or the sound from the earphone or headphone and/or from the mobile device, and for allowing the sound to be shared and listened or heard by people.

### 2. Description of the Prior Art

Various kinds of typical earphones or headphones have been developed and provided for attaching or engaging onto the head and the ears of the user and for receiving and/or magnifying or amplifying the current or the sound or the information from the other electric facilities, such as tablets, notebooks, mobile devices, portable phones, etc., and for allowing the sound to be listened or heard by user only.

However, the sound sent out from the typical earphones or headphones may only be listened or heard by user who wear the typical earphones or headphones, but may not be shared and listened or heard by the other people or persons, such that the information or sound may not be listened or heard or shared between people or friends.

The present invention has arisen to mitigate and/or obviate the afore-described disadvantages of the conventional sound amplifying facilities for earphones or headphones or mobile devices.

### SUMMARY OF THE INVENTION

The primary objective of the present invention is to provide a sound amplifying facility for magnifying or amplifying the current or the sound from the earphones or headphones and/or from the mobile devices, and for allowing the sound to be shared and listened or heard by people.

In accordance with one aspect of the invention, there is provided an amplifying facility comprising a headphone including a wireless transmitting and receiving module for transmitting and receiving an information from an electric facility, and an amplifying mechanism including a signal receiving and amplifying module for receiving and amplifying the information from the headphone and for allowing the sound to be listened or heard by people, but not the user only, and for allowing the information or sound to be listened or heard or shared between people or friends.

The headphone includes a wireless charging module, and the amplifying mechanism includes a wireless charging unit for charging the headphone wirelessly and for allowing the headphone to be selectively and suitably charged.

The amplifying mechanism includes a socket for receiving or engaging with the headphone. The socket includes a conductor, and the headphone includes a terminal for engaging with the conductor of the socket and for allowing the data or information or signal or sound from the headphone to be received and amplified and for allowing the sound to be listened or heard by people, but not the user only.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a sound amplifying facility in accordance with the present invention;

FIGS. 2, 3, 4 are other partial exploded views similar to FIG. 1, illustrating the operation of the sound amplifying facility for earphones or headphones or mobile devices; and

FIG. 5 is a block diagram illustrating the parts or elements of the sound amplifying facility.

### DETAILED DESCRIPTION OF THE PREFERRED EMBODIMENT

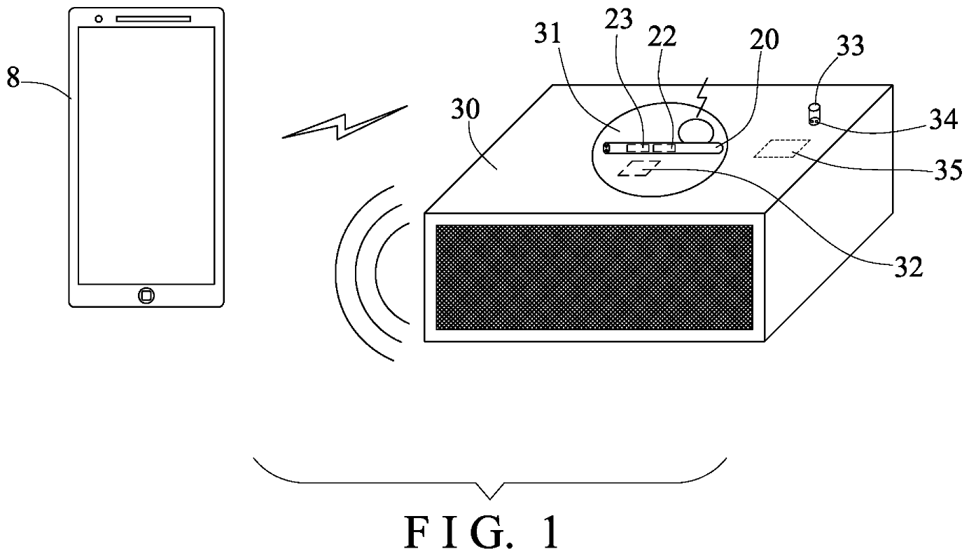

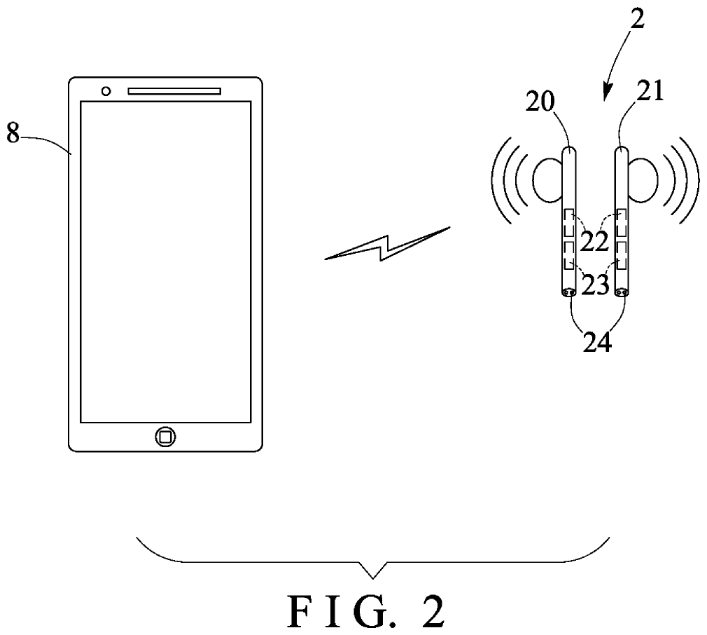

Referring to the drawings, and initially to FIGS. 1 and 2, a current or sound amplifying facility in accordance with the present invention is provided for receiving the current or signal or sound or information from the other electric facilities 8, such as tablets, notebooks, portable phones, mobile devices 8, etc. with an earphone or headphone assembly 2, and for magnifying or amplifying the current or the signal or the sound from the earphone or headphone assembly 2 and/or from the mobile devices 8, and for allowing the sound to be listened or heard by people.

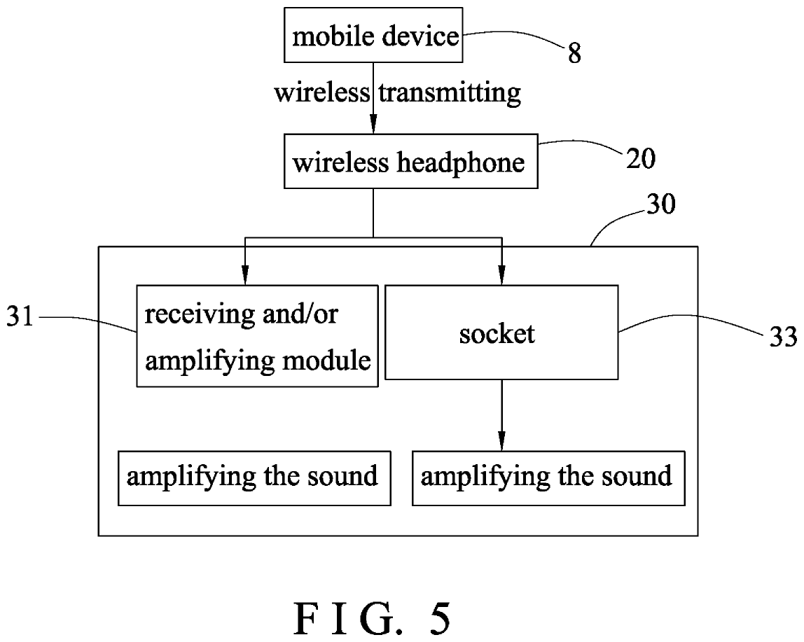

For example, as shown in FIG. 2, the earphone or headphone assembly 2 may include one or more earphones or headphones 20, 21 each having a wireless transmitting and/or receiving module 22 for transmitting and/or receiving the data or information or signal or sound from the other electric facilities or mobile devices 8, a wireless charging and/or discharging module 23 for allowing the headphone 20 to be suitably charged wirelessly, and a conductor or plug member or terminal 24 for selectively and electrically connecting or coupling to the other electric facilities 30 such as the current or signal or information or sound amplifying device or mechanism 30 (FIGS. 1 and 3-5) or the like.

For example, as shown in FIGS. 1 and 3-5, the sound amplifying mechanism 30 includes a signal receiving or reception and/or magnifying or amplifying module 31 for receiving and/or magnifying or amplifying the data or information or signal or sound from the headphone 20 and for allowing the sound to be listened or heard by people, but not the user only. As shown in FIG. 1, the amplifying mechanism 30 further includes a wireless charging and/or discharging module or unit 32 for charging the headphone 20 through the wireless charging and/or discharging module 23 of the headphone 20.

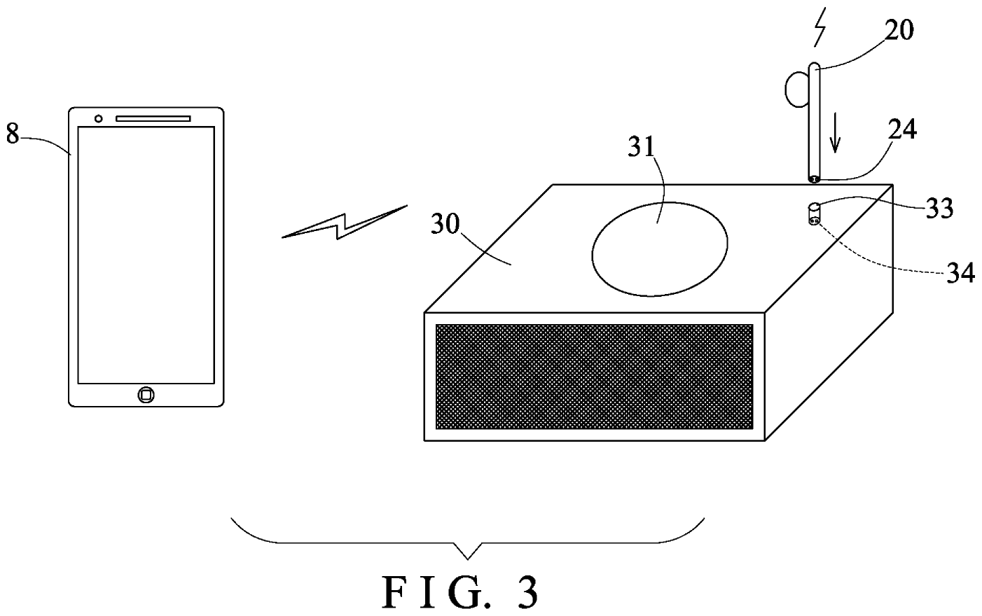

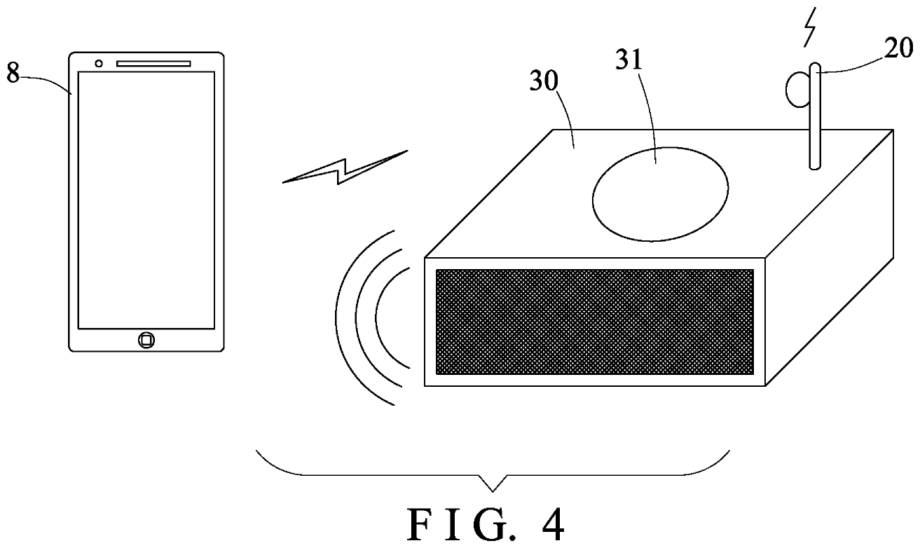

As shown in FIGS. 1 and 3, the amplifying mechanism 30 further includes another conductor or plug member or terminal or socket 33 formed or provided therein for receiving or engaging with the headphone 20 (FIGS. 3, 4) and for receiving and/or magnifying or amplifying the data or information or signal or sound from the headphone 20 and for allowing the sound to be listened or heard by people, but not the user only. The socket 33 may include another terminal or plug member or conductor 34 for selectively and electrically connecting or coupling to or engaging with the terminal 24 of the headphone 20.

The charging module 33 of the amplifying mechanism 30 may also be used for engaging the headphone 20 wirelessly; or the amplifying mechanism 30 may further include another charging and/or discharging module or unit 35 electrically connected or coupled to the socket 33 for engaging the headphone 20 through the socket 33 with or without the wireless charging unit 32 of the amplifying mechanism 30.

In operation, as shown in FIG. 1, the headphone 20 may be disposed and arranged or located close to the signal receiving or reception and/or magnifying or amplifying module 31 which may receive and/or magnify or amplify the data or information or signal or sound from the headphone 20 selectively, for allowing the sound to be listened or heard by people, but not the user only. The headphone 20 may be selectively and suitably charged wirelessly by or with the wireless charging unit 32 of the amplifying mechanism 30.

Alternatively, as shown in FIGS. 3 and 4, the headphone 20 may also be engaged with the socket 33 of the amplifying mechanism 30 which may also receive and/or magnify or amplify the data or information or signal or sound from the headphone 20 for allowing the sound to be listened or heard by people, but not the user only. The headphone 20 may also be selectively and suitably charged through the socket 33 with or without the wireless charging unit 32 of the amplifying mechanism 30.

Accordingly, the sound amplifying facility in accordance with the present invention may be provided for magnifying or amplifying the current or the sound from the earphones or headphones and/or from the mobile devices, and for allowing the sound to be shared and listened or heard by people.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An amplifying facility comprising:
a headphone including a wireless transmitting and receiving module for transmitting and receiving an information from an electric facility, and
an amplifying mechanism including a signal receiving and amplifying module for receiving and amplifying the information from said headphone.

2. The amplifying facility as claimed in claim 1, wherein said headphone includes a wireless charging module, and said amplifying mechanism includes a wireless charging unit for charging said headphone wirelessly.

3. The amplifying facility as claimed in claim 1, wherein said amplifying mechanism includes a socket for engaging with said headphone.

4. The amplifying facility as claimed in claim 3, wherein said socket includes a conductor, and said headphone includes a terminal for engaging with said conductor of said socket.
